(19) United States
(12) Patent Application Publication
(10) Pub. No.: US 2008/0223785 A1
(43) Pub. Date: Sep. 18, 2008

(54) Ionic Polymer Membranes

(76) Inventors: Jeffrey T. Miller, Naperville, IL (US); George A. Huff, Naperville, IL (US); William John Koros, Atlanta, GA (US); Charles Richard Hoppin, Alpharetta, GA (US)

Correspondence Address: CAROL WILSON;BP AMERICA INC., MAIL CODE 5 EAST, 4101 WINFIELD ROAD, WARRENVILLE, IL, 60555, US

(21) Appl. No.: 11/685,461

(22) Filed: Mar. 13, 2007

(51) Int. Cl. B01D 61/00

(52) U.S. Cl. 210/654

(57) ABSTRACT

Compositions and processes are disclosed for economical separation of fluid mixtures. Broadly, the present invention discloses ionic polymer compositions that are useful for perm-selective membrane separations. More particularly, ionic polymers of the invention comprise a plurality of repeating structural units having as a constituent part thereof organic ionic moieties consisting of nitrogen containing anions and/or cations. In the form of non-porous membranes, ionic polymers of the invention facilitate recovery of purified organic and inorganic products from fluid mixtures by means of perm-selective membrane separations. The present invention also provides methods for forming the ionic polymers, for example by treating selected nitrogen-containing organic polymers with acids, or treating a polymeric material comprising a plurality of carboxylate groups with an amine. Ionic polymer compositions of the invention are particularly useful for simultaneous recovery of a permeate product of an increased concentration, and a desired non-permeate stream, from a fluid mixture containing at least two compounds of different boiling point temperatures.

### TECHNICAL FIELD

The present invention relates to ionic polymer compositions that are useful for perm-selective membrane separations. More particularly, ionic polymers of the invention comprise a plurality of repeating structural units having as a constituent part thereof organic ionic moieties consisting of nitrogen containing anions and/or cations. In the form of non-porous membranes, ionic polymers of the invention facilitate recovery of purified organic and inorganic products from fluid mixtures by means of perm-selective membrane separations.

Ionic polymer compositions of the invention are particularly useful for simultaneous recovery of a permeate product of an increased concentration, and a desired non-permeate stream, from a fluid mixture containing at least two compounds of different boiling point temperatures.

As will be described in greater detail hereinafter, the present invention provides methods for forming the ionic polymers, for example be treating selected nitrogen-containing organic polymers with acids, or treating a polymeric material comprising a plurality of carboxylate groups with an amine.

### BACKGROUND OF THE INVENTION

Materials that exhibit different rates at which different organic compounds penetrate and pass through the material in the form of a film, thin sheet, or membrane have been sought for many years. Such materials advantageously enable the concentration and recovery of desirable light hydrocarbons, for example without expensive distillation steps.

The separation of gases by diffusion through a porous diffusion partition has been proposed in U.S. Pat. No. 1,496,757 issued, in the name of Lewis, et al., Jun. 3, 1924, for “Process of Separating Gases.” In porous materials, the rates at which different gases diffuse vary inversely with the square root of their density or molecular weight. While porous diffusion might be used conveniently for separating gases having wide difference in density or molecular weight, such, for example, as hydrogen from carbon dioxide or helium from natural gas, it would be entirely unsuitable for separating gases having approximately the same densities or molecular weight, such as propylene and propane.

In U.S. Pat. No. 2,159,434, issued in the name of Frederick E. Frey on May 23, 1939, a process for concentrating hydrocarbons is proposed that is based upon the discovery that hydrocarbons, in the vapor state, pass through non-porous substances such as rubber and the like at rates depending on the molecular weight, saturation and molecular structure of the hydrocarbon molecule. Frey states that the solubility of the hydrocarbon in rubber and its equivalents appears to be the mechanism whereby the hydrocarbon vapor passes into one face and out of the other face of a rubber membrane. It was found that among the lower paraffins and olefins the rate of passage through a thin rubber wall increases with carbon number.

Facilitated transport membrane systems have been known for many years and widely researched, particularly for oxygen purification from air. See for a review of the general area the work of S. G. Kimura, S. L. Matson and W. J. Ward, III, in Recent Advances in Separations Science Vol. 5, N. N. Li, Ed. CRC Press, Cleveland, 1979, p. 11. The facilitated transport systems described the use of membranes in conjunction with metal complexing techniques to facilitate the separation of, for example ethylene from ethane and methane. Silver ion has been used exclusively in these systems since first disclosed in U.S. Pat. No. 3,758,603, in the name of Edward F. Steigelmann and Robert D. Hughes, and improved processes of these types in, for example, U.S. Pat. Nos. 3,864,418; 3,980,605; 4,060,566; 4,106,920; and 4,239,506.

Several of these patents described methods for separating materials such as aliphatically-unsaturated hydrocarbons and carbon monoxide, from mixtures containing them, and these procedures involve the combined use of liquid barrier permeation and metal-complexing techniques which can exhibit high selectivity factors. In the processes, the liquid barrier is an aqueous solution having metal-containing ions which will complex with the material to be separated, and the liquid barrier is employed in conjunction with a semi-permeable membrane which is essentially impermeable to the passage of liquid. In several systems of this type, the liquid barrier containing the complex-forming ions is in contact with the membrane and typically is at least partially contained in a hydrophilic, semi-permeable film membrane. When operating in this manner, it is not necessary to maintain contact of the film with a separate or contiguous aqueous, complex-forming, liquid phase during the process.

Processes of these types in which a material is separated from a fluid mixture by utilizing an essentially solid, water-insoluble, hydrophilic, semi-permeable membrane having therein an aqueous liquid barrier containing ions which combine with the material to be separated to form a water-soluble complex, and during the separation, an aqueous liquid medium, i.e., an aqueous, non-sweep liquid medium, e.g. water in the liquid phase, with or without other constituents, is provided on the exit surface of the membrane from a source extraneous to the membrane to decrease water loss from the film and thereby enhance the operation of the separation system. In the process a material is separated from a feed mixture by contacting the latter with a first side of the membrane while having a partial pressure of the material on a second or exit side of the semi-permeable membrane which is sufficiently less than the partial pressure of the material in the mixture to provide separated material on the second side of the membrane. The separated material can be removed from the vicinity of the second side of the membrane by, for instance, a sweep gas. By the process of this invention, the loss of water from aqueous liquid barrier in the membrane is materially reduced and decreases in permeability and selectivity during operation are thereby minimized. Similar results were not obtained when the feed mixtures and sweep gas are merely saturated with moisture. All of the facilitated transport systems described operated at low trans-membrane pressure, typically using a sweep gas to reduce partial pressure of the product in the permeate stream.

Evaluation of facilitated transport membrane process for the separation of propylene from propane is described by J. Davis et al. in an article entitled “Facilitated Transport Membrane Hybrid Systems for Olefin Purification” published in Sep. Sci. Tech 28, 463-476 (1993). Davis et al. used a silver nitrate solution in a hybrid membrane system to obtain selectivities for propylene transport that were in excess of 150.

Ion exchange membranes were first proposed by O. H. LeBlanc, Jr., et al. in J. Membr. Sci. 6, 339 1980. LeBlanc, et al. at GE used Nafion® and other cation exchangers loaded with silver ion for olefin separation from non-olefins. Several other research groups have worked on these systems.

Metal complex and membrane hybrid systems have been described, for example by Robert L. Yahnke in U.S. Pat. No. 4,060,566. Yahnke reporting in 1977 a system where he trickled a stream of silver ion solution down the outside of hollow fibers to keep the liquid in the membrane pores. He was also limited to low trans-membrane pressures and used a sweep gas.

Similar metal complex and membrane hybrid processes have been described by Menahem A. Kraus in U.S. Pat. No. 4,614,524, for water-free hydrocarbon separation membrane, and by Ronald J. Valus et al. in U.S. Pat. No. 5,057,641, using a porous membrane and a facilitator liquid. These processes utilize a separation unit containing a membrane having a feed side and a permeate side with a liquid between them that contains a metal-containing ion complexing agent. Transport of the desired component is described as occurring by a) dissolving the component in the facilitator liquid on the feed side of the membrane; b) forming a component-carrier complex; c) diffusing the complex to the permeate side of the membrane; and d) releasing the component from the carrier. The selectivity of the membrane is maximized by choosing a complexing agent with a high affinity for the desired component. The agent facilitates the transport of the desired component from the feed stream to the permeate.

Although many of the systems in the literature worked in the laboratory, only one is described as having been tested at pilot scale. Hughes, Mahoney, and Steigelmann reported the use of cellulose acetate hollow fiber membranes as liquid membrane supports for silver solutions used for the separation of propylene from nitrogen in Recent Advances in Separations Science Vol. 9, N. N. Li, and J. M. Calo, Eds. CRC Press, Cleveland, 1986, p. 173. The membrane used was asymmetric, with a thin, dense skin designed for reverse osmosis and sold by the Dow Chemical Co. as an RO-4K permeator.

Much of the data available to date on this separation using facilitated membranes reports the use of either ion exchange membranes or microporous membranes. In the case of the ion exchange membranes, even though they will withstand substantial trans-membrane pressure, studies in our laboratory showed that at substantially higher trans-membrane pressures the membrane flux was not much higher than that at lower pressures. The microporous membranes suffer from a low bubble point due to the pore diameter and only moderate trans-membrane pressures can be tolerated without forcing the liquid out of the pore. As demonstrated in the work of Hughes, et al. (5), cellulose membranes are severely weakened by the silver nitrate solution. As a result the trans-membrane pressure Hugh's membrane could withstand was substantially reduced. This is a common problem, many polymers either swell or dissolve in strong transition metal ion solutions. Hence, all of the olefin facilitated membrane systems either can't operate at the required trans-membrane pressure or exhibit no advantage in doing so.

Due to their extensive use in the polymer industry and as solvents, there is a continuing need for better separation processes for alkenes and other unsaturated organic compounds from alkanes. Perfluorosulfonic acid membranes, such as Nafion®, that have been ion-exchanged with silver(I) ion exhibit large transport selectivities for many unsaturated hydrocarbons with respect to saturates with similar physical properties. These selectivities are the result of reversible compexation reactions between the unsaturated molecules and Ag+, which results in facilitated transport through the membranes.

The concept of using Ag+ in liquid membranes to promote facilitate transport of simple gaseous alkenes, specifically ethylene/ethane separations, began with papers by LaBlanc et al. in J. Membr. Sci. 1980, 6, 339 and Teramoto et al. in, for example, J. Membr. Sci. 1990, 50, 269. Interest in this process waned somewhat when it was discovered that Ag+ formed explosive side products with acetylene which was present in the feed stocks. Despite this potential problem, researchers at BP America developed a Ag+-based separation process for propene/propane separation.

Several research groups have explored the use of Ag+-exchanged Nafion® membranes for the separation of various liquid phase unsaturates (See, for example, Thoen et al. C. A. J. Phys. Chem. 1994, 98, 1262). Nafion® is a perfluorosulfonate membrane with outstanding chemical and thermal stability. Many studies have been performed on the chemical, morphological and structural properties of perfluorosulfonate ionomers. The chemical structure of Nafion® consists of a Teflon-like backbone containing side chains that are ether linked and terminate in a sulfonate group. Due to the extremely hydrophilic sulfonate groups and the very hydrophobic fluorocarbon backbone, the microstructure of Nafion® consists of a series of ionic clusters interconnected by a network of channels. Nafion® can absorb relatively large amounts (about 10-30% by mass) of water and other polar solvents due to the hydrophilicity of the ionic clusters. Data from X-ray and neutron scattering experiments indicate that the ionic clusters are approximately 50 Å in diameter while the channels that connect them are 10 Å wide.

Commercially available Nafion® is 180 μm thick an has an equivalent weight of 1100 g/mol, indicating that most of the mass of the membrane is due to the fluorocarbon backbone. Nafion® of 1100 equivalent weight is also commercially available as a solution. The casting of membranes from this solution has been studied and procedures have been developed make membranes with thicknesses as small as 2.5 μm.

One of several disadvantages of this facilitated-transport type membrane unit is its high investment cost and complexity of operation. Others include expenses to operate because of the large internal recycle of solvent. Additionally, the effluents streams must be separated distillation from the solvent. Thus, energy costs can be very significant.

Currently, however, virtually all industrial scale separations of hydrocarbons are performed by distillation. Distillation alone is inherently inefficient when the vapor/liquid equilibrium line is close to the operating lines in McCabe-Thiele diagrams. This occurs when components have similar volatilities, from azeotrope(s), or when high product purity is required.

There is, therefore, a present need for improved compositions that are useful for perm-selective membrane separations. Particularly desirable should be polymers that facilitate recovery of purified organic products from fluid mixtures by means of perm-selective membrane separations, and which exhibit as well as appreciable selective permeability.

New materials for membrane separations should beneficially exhibit greater stability when exposed to operating conditions for extended time periods. Particularly beneficially should be new materials which form non-porous membranes that exhibit negligible vapor pressure under ambient conditions.

Furthermore, new composition should advantageously provide stable materials for membranes that are free of interfacial surfaces between a continuous phase and particles of a discontinuous phase at which surfaces leakage can occur.

It is an object of the invention to overcome one or more of the problems described above.

Other advantages of the invention will be apparent to those skilled in the art from a review of the following detailed description, taken in conjunction with the drawing and the appended claims.

### SUMMARY OF THE INVENTION

In broad aspect, the present invention is directed to ionic polymer compositions that exhibit an ability to facilitate recovery of purified products from fluid mixtures by means of perm-selective membrane separations. More particularly, polymers of the invention are useful as a component in perm-selective membranes for recovery of a permeate product and a non-permeate product from a fluid mixture that typically includes one or more organic compound.

Under a suitable differential of a driving force, a solid perm-selective membrane comprising a polymer of the invention beneficially exhibits a permeability and other characteristics suitable for the desired separations, and may be used in separation processes according to the invention. Advantageously membranes of the invention exhibit a permeability of at least 0.1 Barrer for one of the compounds of the feedstock.

The invention provides ionic polymer compositions that may be understood as polymeric salts comprising repeating structure units that include organic ionic moieties containing nitrogen. These integral ionic moieties may comprise monovalent or polyvalent anions or cations. The ionic polymer may contain ionic moieties of a single salt or a mixture of salts.

The ionic polymer compositions of the inventions have advantageously negligible vapor pressures under ambient conditions. These ionic polymers are therefore particularly useful components of non-porous membranes in a perm-selective process for recover of permeate and non-permeate products from a fluid mixture of compounds.

The invention is directed to ionic polymer compositions comprising repeating structural units that comprise a plurality of repeating structural units having as a constituent part thereof organic ionic moieties consisting of nitrogen containing anions and/or cations. In one aspect the ionic polymer composition according to the invention contains at least a plurality of the organic ionic moieties consisting of nitrogen containing cations and anions selected from the group consisting of hydroxide, chloride, bromide, iodide, borate, tetrafluoroborate, phosphate, hexafluorophosphate, hexafluroantimonate, perchlorate, nitrite, nitrate, sulfate, a carboxylate, a sulfonate, a sulfonimide, and a phosphonate.

In one aspect of the invention, an ionic polymer composition comprises repeating structure units that include organic ionic moieties consisting of anions and nitrogen containing cations having a ring structure of 5 to 6 members comprising from 1 to 3 nitrogen atoms, and from 2 to 5 carbon atoms.

In another aspect of the invention, an ionic polymer composition comprises repeating structure units that include organic ionic moieties consisting of anions and nitrogen containing cations having a ring structure of 5 members comprising from 2 or 3 nitrogen atoms, and 2 or 3 carbon atoms.

In another aspect of the invention, an ionic polymer composition comprises repeating structure units that include organic ionic moieties consisting of anions and nitrogen containing cations having a ring structure of 5 members comprising 1 to 2 nitrogen atoms, 2 to 3 carbon atoms, and a member selected from the group consisting of oxygen and sulfur atoms and an organic nitrogen containing group.

According to the invention, an ionic polymer composition useful as a component in perm-selective membranes for recovery of a permeate and a non-permeate products from a fluid mixture of compounds, comprises a repeating organic structure having an ionic moiety comprising an acetate, nitrate or sulfonate of at least one member of the class 1-ethyl-2-butylpyrrolidine, triethylamine, propylamine, 1,5-dimethyl-2-pyrrolidine, 1-butylpyrrolidine, tributylamine, 1-(2-hydroxyethyl)pyrrolidine, 1-methylpiperidine, 1-pyrrolidinebutyronitrile, and 4-hydroxy-1-methylpiperidine.

In yet another aspect of the invention, an ionic polymer composition comprises repeating structure units of which at least a plurality are represented by

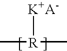

where, K⁺ A⁻ is an organic ionic moiety consisting of a nitrogen containing cation K⁺ and an anion A⁻, and R is a organic group comprising 2 or more carbon atoms.

In these ionic polymer compositions, the nitrogen containing cations can comprise a ring structure of 5 to 6 members comprising from 1 to 3 nitrogen atoms, and from 2 to 5 carbon atoms; a ring structure of 5 members comprising from 2 or 3 nitrogen atoms, and 2 or 3 carbon atoms; and/or a ring structure of 5 members comprising a nitrogen atom, 3 carbon atoms, and an atom selected from the group consisting of oxygen and sulfur atoms. Useful organic ionic moieties in compositions of the invention include an anion selected from the group consisting of acetate, fluoride, chloride, nitrate, sulfate, tetrafluoroborate, trifluoromethane sulfonate, hexafluorophosphate, trichloroacetate, trifluoroacetate and tribromoacetate. The organic cations in compositions of the invention may beneficially comprise a member of the group consisting of 1-ethyl-2-butylpyrrolidine, triethylamine, propylamine, 1,5-dimethyl-2-pyrrolidine, 1-butylpyrrolidine, tributylamine, 1-methylpiperidine, 1-(2-hydroxyethyl)pyrrolidine, 1-pyrrolidinebutyronitrile, and 4-hydroxy-1-methylpiperidine. In ionic polymer compositions of the invention the organic ionic moieties advantageously comprises an acetate, nitrate or sulfonate of at least one member of the group consisting of 1-ethyl-2-butylpyrrolidine, triethylamine, propylamine, 1,5-dimethyl-2-pyrrolidine, 1-butylpyrrolidine, tributylamine, 1-methylpiperidine, 1-(2-hydroxyethyl)pyrrolidine, 4-hydroxy-1-methylpiperidine, and 1-pyrrolidinebutyronitrile.

The invention also provides an ionic polymer composition useful as a component in perm-selective membranes for recovery of a permeate and a non-permeate products from a fluid mixture of compounds, that is an ionic polymer composition comprising repeating structure units of which at least a plurality are represented by

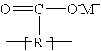

where O═C—O⁻ M⁺ is an ionic moiety wherein M⁺ is a nitrogen containing cation from an amine, and R is a organic group comprising 2 or more carbon atoms.

The term “amine” refers to aliphatic amines, which included primary amines, secondary amines, tertiary amines, diamines and ethanolamines, and/or aromatic amines, such as benzylamine, aniline, the nitroaminines and diphenylamine. In these ionic polymer compositions, the nitrogen containing cation can be derived from an aliphatic amine of 12 or less carbon atoms, and/or from an aromatic amine of 12 or less carbon atoms.

In another aspect, the invention provides an ionic polymer composition useful as a component in perm-selective membranes for recovery of a permeate and a non-permeate products from a fluid mixture of compounds, that is an ionic polymer composition comprising repeating structural units containing one or more nitrogen atoms of which at least a plurality are represented by

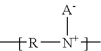

where R is a organic unit comprising 2 or more carbon atoms, and A⁻ is an anion.

The invention provides process for making an ionic polymer membrane, which process comprises: (a) treating a nitrogen-containing polymeric material with an acid in a liquid system; and (b) forming a solid membrane from the treated material. For example, ionic polymer membranes of the invention are made by (a) treating a nitrogen-containing a polymeric material with an acid in a liquid medium comprising a solvent; and (b) removing the solvent from the resulting mixture thereby forming a solid membrane.

For example, the nitrogen-containing polymeric material may be a selected polyethylenimine of suitable molecular weight. Polyethylenimine is produced by polymerization of ethylenimine and has previously had a wide variety of commercial applications such as adhesives, flocculating agents, ion exchange resins, complexing agents, absorbents, etc. It is a highly branched polyamine with amino nitrogens in the ratio of primary:secondary:tertiary of about 1:2:1. It is available in a wide range of molecular weights of about 600 to 100,000, all of which are soluble in water, giving slightly hazy appearing solutions.

The molecular weight of the polyethylenimine is not a critical factor in the invention, although optimum values may vary depending on various factors, such as the type of support, nature of the feed mixture and desired separation, and flux desired. Generally, a molecular weight of about 600 to 100,000 is suitable, with about 12,000 to 100,000 usually being preferred.

A film of the treated polyethylenimine, for example may be prepared from a solution of the ionic polymer in water. This solution is usually most easily prepared by gradual dilution of the treated polyethylenimine with water until the desired concentration is obtained. Mixing is continued until a uniform hazy appearing solution is obtained and, preferably, the solution is then filtered. For best results the concentration of ionic polymer in the aqueous solution depends on the molecular weight of the ionic polymer. For a higher molecular weights, i.e., about 50,000 to 100,000, a concentration of 0.3 to 2 percent usually gives best results. For lower molecular weights, i.e., about 600 to 12,000, a concentration of about 2 to 6 percent is usually preferred.

A film of ionic polymer on a support may be prepared by any conventional procedure. Examples of such procedures include casting a solution of the ionic polymer onto the support, dipping or immersing the support in solution, etc. (The most practical and useful solvent for the treated polyethylenimine is water).

An ionic polymer membrane of this type also may be made by treating a polyvinylpyrrolidone and/or copolyvidone with an acid in a liquid system; and (b) forming a solid membrane from the treated material. In the present invention, for example polyvinylpyrrolidone is a linear polymer of 1-vinyl-2-pyrrolidone having an average molecular weight in a range from several thousand to a few million, typically from about 10,000 to about 2,000,000. A copolyvidone is a copolymer of a chain-structured vinyl pyrrolidone and vinyl acetate, for example in a ratio of 6:4. As indicated above, the polyvinylpyrrolidone and copolyvidone may be used either singly or in combination (See “polyvinylpyrrolidone” under Materials Research Science and Engineering Center at www.psrc.usm.edu).

Suitable starting polymeric materials include, but are not limited to, any copolymers of vinylpyrrolidone with other comonomers such as styrene, vinylacetate, various amino methacrylates, and other monomers that can polymerize with vinylpyrrolidone. Many other nitrogen-containing polymers can be used including, but not limited to, homopolymers or copolymers made from vinylimidazole, vinylpyridine, vinylcarbazole, vinylcaprolactam, aminomethacrylates, and vinylpiperidines. The nitrogen may be neutral or ionized before or after polymerization. Other polymers with nitrogen-bearing moieties can be made by well-known grafting methods and also could be considered as candidates. (Also see Membrane Handbook/editors, W. S. Winston Ho and Kamalesh K. Sirkar, Van Nostrand Reinhold, New York (1992), for example beginning at page 186.)

In another aspect, the invention provides process for making an ionic polymer membrane, which process comprises: (a) treating a polymeric material comprising a plurality of carboxylate groups with an amine in a liquid system; and (b) forming a solid membrane from the treated material. For example, ionic polymer membranes of the invention are made by (a) treating a polymeric material comprising a plurality of carboxylate groups, such as a poly(acrylic acid) and/or poly(methacrylic acid) of suitable molecular weight, with an amine in a liquid medium comprising a solvent; and (b) removing the solvent from the resulting mixture thereby forming a membrane. (See F. W. Billmeyer, Jr., “Textbook of Polymer Science” 2ed, John Wiley & Sons, (1971), for example beginning at page 412)

The invention also provides a process for recovery of permeate and non-permeate products from a fluid mixture of compounds, which process comprises: contacting a fluid mixture of two or more volatile compounds with a first side of a membrane that contains an ionic polymer of repeating structural units having organic ionic moieties consisting of nitrogen containing organic cations or anions; maintaining a suitable differential of a driving force across the membrane from the first side to a permeate side opposite thereto, under which differential of a driving force the membrane exhibits a permeability for one of the compounds of the fluid mixture, and recovering one or more compounds from the permeate side of the membrane. Particularly useful in these processes are the membranes that exhibit a permeability of at least 0.1 Barrer for one of the compounds of the fluid mixture.

Advantageously apparatus with perm-selective membranes comprising ionic polymer compositions of the invention, is employed for simultaneous recovery of a very pure permeate product and another desired product from a mixture containing organic compounds. This invention is particularly useful towards separations involving organic compounds, in particular compounds which are difficult to separate by conventional means such as fractional distillation alone. Typically, these include organic compounds are chemically related as for example alkanes and alkenes of similar carbon number.

The film membranes can be essentially homogenous materials which are suitable for forming into various shapes, and the membranes may be formed by, for instance, extrusion and can be made into hollow fiber forms. These fibers are preferred membrane configurations because they have the advantages of high surface area per unit volume, thin walls for high transport rates, and high strength to withstand substantial pressure differentials across the membrane or fiber walls.

For a more complete understanding of the present invention, reference should now be made to the embodiments described in greater detail below and by way of examples of the invention.

### GENERAL DESCRIPTION

The invention contemplates ionic polymer compositions that are useful for perm-selective membrane separations. More particularly, ionic polymers of the invention have a plurality of repeating structural units that include organic ionic moieties consisting of nitrogen containing anions and/or cations.

Carboxylates useful as anions include alkylcarboxylates, for example as acetate, substituted alkylcarboxylates, for example as lactate, and haloalkylcarboxylates, for example as trifluoroacetate, and the like.

Sulfonates useful as anions include alkylsulfonates, for example as mesylate, haloalkylsulfonates, for example as triflate and nonaflate, and arylsulfonates, for example as tosylate and mesitylate, and the like.

Sulfonimides useful as anions may be mono- or disubstituted sulfonimides, for example as methanesulfonimide and bis ethanesulfonimide, optionally halogenated sulfonimides, for example as bis trifluoromethanesulfonimide, arylsulfonimides, for example as bis (4-methoxybenzene)sulfonamide, and the like.

Phosphonates useful as anions include alkylphosphonates, for example as tert-butylphosphonate, and arylphosphonates, for example as 3,4-dichlorophenylphosphonate, and the like.

In one embodiment, the ionic polymer that may be understood as polymeric salts comprising repeating structure units that include organic ionic moieties containing nitrogen selected from the group of imidazolium salts, pyrazolium salts, oxazolium salts, thiazolium salts, triazolium salts, pyridinium salts, pyridazinium salts, pyrimidinium salts, and pyrazinium salts. Illustrative of such compounds are 1-ethyl-3-methylimidazolium chloride, 1-butyl-3-ethylimidazolium chloride, 1-butyl-3-methylimidazolium chloride, 1-butyl-3-methylimidazolium bromide, 1-methyl-3-propylimidazolium chloride, 1-methyl-3-hexylimidazolium chloride, 1-methyl-3-octylimidazolium chloride, 1-methyl-3-decylimidazolium chloride, 1-methyl-3-dodecylimidazolium chloride, 1-methyl-3-hexadecylimidazolium chloride, 1-methyl-3-octadecylimidazolium chloride, 1-ethylpyridinium bromide, 1-ethylpyridinium chloride, 1-butylpyridinium chloride, and 1-benzylpyridinium bromide, 1-butyl-3-methylimidazolium tetrafluoroborate, 1-butyl-3-methylimidazolium iodide, 1-butyl-3-methylimidazolium nitrate, 1-ethyl-3-methylimidazolium tetrafluoroborate, 1-ethyl-3-methylimidazolium bromide, 1-ethyl-3-methylimidazolium iodide, 1-ethyl-3-methylimidazolium nitrate, 1-butylpyridinium tetrafluoroborate, 1-butylpyridinium bromide, 1-butylpyridinium iodide, 1-butylpyridinium nitrate, 1-butyl-3-methylimidazolium hexafluorophosphate, 1-octyl-3-methylimidazolium hexafluorophosphate, 1-octyl-3-methylimidazolium tetrafluoroborate, 1-ethyl-3-methylimidazolium ethylsulfate, 1-butyl-3-methylimidazolium triflate, 1-butyl-3-methylimidazolium acetate, 1-butyl-3-methylimidazolium trifluoroacetate, and 1-butyl-3-methylimidazolium bis(trifluoromethanesulfonimide).

Ionic polymer compositions are used in accordance with the invention in any solid perm-selective membrane which under a suitable differential of a driving force exhibits a permeability and other characteristics suitable for the desired separations. Suitable membranes may take the form of a homogeneous membrane, a composite membrane or an asymmetric membrane which, for example may incorporate a gel, a solid, or a liquid layer. Widely used polymers include silicone and natural rubbers, cellulose acetate, polysulfones and polyimides.

Preferred membranes for use in separation embodiments of the invention are generally of two types. The first is a composite membrane comprising a microporous support, onto which the perm-selective layer is deposited as an ultra-thin coating. Composite membranes are preferred when a rubbery ionic polymer is used as the perm-selective material. The second is an asymmetric membrane in which the thin, dense skin of the asymmetric membrane is the perm-selective layer. Both composite and asymmetric membranes are known in the art. The form in which the membranes are used in the invention is not critical. They may be used, for example, as flat sheets or discs, coated hollow fibers, spiral-wound modules, or any other convenient form.

The driving force for separation of vapor components by ionic polymer membrane permeation is a differential of chemical potential that for example includes, predominately their partial pressure difference between the first and second sides of the membrane. The pressure drop across the ionic polymer membrane can be achieved by pressurizing the first zone, by evacuating the second zone, introducing a sweep stream, or any combination thereof.

Suitable types of membrane modules include the hollow-fine fibers, capillary fibers, spiral-wound, plate-and-frame, and tubular types. The choice of the most suitable membrane module type for a particular membrane separation must balance a number of factors. The principal module design parameters that enter into the decision are limitation to specific types of membrane material, suitability for high-pressure operation, permeate-side pressure drop, concentration polarization fouling control, permeability of an optional sweep stream, and last but not least costs of manufacture.

Hollow-fiber membrane modules are used in two basic geometries. One type is the shell-side feed design, which has been used in hydrogen separation systems and in reverse osmosis systems. In such a module, bundle of fibers is contained in a pressure vessel. The system is pressurized from the shell side; permeate passes through the fiber wall and exits through the open fiber ends. This design is easy to make and allows very large membrane areas to be contained in an economical system. Because the fiber wall must support considerable hydrostatic pressure, the fibers usually have small diameters and thick walls, e.g. 100 μm to 200 μm outer diameter, and typically an inner diameter of about one-half the outer diameter.

A second type of hollow-fiber module is the bore-side feed type. The fibers in this type of unit are open at both ends, and the feed fluid is circulated through the bore of the fibers. To minimize pressure drop inside the fibers, the diameters are usually larger than those of the fine fibers used in the shell-side feed system and are generally made by solution spinning. These so-called capillary fibers are used in ultra-filtration, pervaporation, and some low- to medium-pressure gas applications.

Concentration polarization is well controlled in bore-side feed modules. The feed solution passes directly across the active surface of the membrane, and no stagnant dead spaces are produced. This is far from the case in shell-side feed modules in which flow channeling and stagnant areas between fibers, which cause significant concentration polarization problems, are difficult to avoid. Any suspended particulate matter in the feed solution is easily trapped in these stagnant areas, leading to irreversible fouling of the membrane. Baffles to direct the feed flow have been tried, but are not widely used. A more common method of minimizing concentration polarization is to direct the feed flow normal to the direction of the hollow fibers. This produces a cross-flow module with relatively good flow distribution across the fiber surface. Several membrane modules may be connected in series, so high feed solution velocities can be used. A number of variants on this basic design have been described, for example U.S. Pat. Nos. 3,536,611 in the name of Fillip et. al., 5,169,530 in the name of Sticker et al., 5,352,361 in the name of Parsed eta al., and 5,470,469 in the name of Beckman which are incorporated herein by reference each in its entirety. The greatest single advantage of hollow-fiber modules is the ability to pack a very large membrane area into a single module.

### EXAMPLES OF THE INVENTION

The following examples will serve to illustrate certain specific embodiments of the herein disclosed invention. These Examples should not, however, be construed as limiting the scope of the novel invention as there are many variations which may be made thereon without departing from the spirit of the disclosed invention, as those of skill in the art will recognize.

### General

Perm-selective transport of fluids can occur by various mechanisms involving molecular scale interactions of the sorption-diffusion type. These can be broadly classified into three groups.

The sorption-diffusion mechanism considers that some thermally agitated motions (either in the matrix or by the penetrant provide opportunities for sorbed penetrants to diffuse from the upstream to the downstream face of a membrane. Like reverse osmosis, the driving force for gas separation is a chemical potential difference related to the concentration difference imposed between the feed and permeate sides of the membrane. For gas separation, this chemical potential difference arises from a partial pressure (or fugacity) difference of the permeating species between the upstream and downstream membrane faces (Koros, W. J. and Hellums, M. W. 1989 in “Concise Encyclopedia of Polymer Science and Engineering,” 2nd ed. pp. 1211-1219, Wiley-Interscience, New York). Such membranes can be further sorted into three groups: polymeric solution-diffusion, molecular sieving, and selective surface flow.

In any case, the “permeability,” P_{A}, of a given gas (A) in a membrane material simply equals the pressure-and-thickness-normalized flux. This parameter provides the overall measure of the ease of transporting the gas through the material.

P_{A}=[flux of A][L]/[Δp_{A}] (1)

In terms of the above Eq. (1), the driving force is Δp_{A} and the resistance, Ω_{A}=L/P_{A}. Although the effective skin thickness L is often not known, the so-called permeance, P_{A}/L can be determined by simply measuring the pressure normalized flux, viz., P_{A}/L=[flux of A]/ΔP_{A}, so this resistance is known.

Since the permeability normalizes the effect of the thickness of the membrane, it is a fundamental property of the polymeric material. Fundamental comparisons of material properties should be done on the basis of permeability, rather than permeance. Since permeation involves a coupling of sorption and diffusion steps, the permeability is a product of a thermodynamic factor, S_{A}, called the solubility coefficient, and a kinetic parameter, D_{A,}, called the diffusion coefficient.

P_{A}=[S_{A},][D_{A},] (2)

The coefficients in Eq. (2) are themselves complex functions that depend upon the type and amount of other sorbed penetrants near the permeating penetrant. Temperature is also an important factor which activates the diffusion jumps and moderates the thermodynamic interaction between the sorbed penetrants and the matrix.

Under ideal conditions with a negligible downstream pressure of both components, the separation factor for component A vs. B, α_{AB}, can be equated to the “ideal membrane selectivity” factored into its mobility and solubility controlled contributions, viz.,

α_{AB}=P_{A}/P_{B}=[D_{A}/D_{B}][S_{A}/S_{B}] (3)

For a defect-free ideal membrane, the selectivity is independent of thickness, and either permeability ratios or permeance ratios can be used for comparison of selectivities of different materials.

One of the parameters in Eq. (3) is the ratio of solubility coefficients. A simple method for determining the solubility of one component relative to another has been developed. The method determines the relative solubility of toluene vs. isooctane from an equivolume mixture of toluene and isooctane. The method, described in more detail in the examples below, involves casting a uniform film of the polymer at the base of a vial and soaking the film for one or more days at room temperature in a mixture of toluene and isooctane with known composition. The refractive index (n_{D}) of the supernatant is determined and compared to the n_{D} measured on a sample of the starting mixture stored in a blank vial. If the n_{D} of the supernatant is significantly lower than the n_{D} of the starting mixture and there is minimal evaporation (less than 5 percent), then it is shown that the solid film has absorbed more toluene than isooctane since the refractive index of toluene is higher than that of isooctane.

Amounts of toluene and isooctane absorbed by the film can be calculated by mass balance using the weights of the dry film, the solvent-wet film, and the starting liquid, along with the n_{D}s of the supernatant and starting liquid. The absorption selectivity (α_{toluene/isooctane}) is defined as the ratio of the absorbed toluene over the absorbed isooctane.

### Example 1

This example demonstrates preparation of a polymer composition from a co-polymer of polyvinylpyrrolidone and polyvinylacetate (PVP-VAc). The co-polymer was purchased from Aldrich Chemical Company, Milwaukee, Wis. 53566 USA (Catalog Number 19,084-5). The average polymer molecular weight (M_{w}) was 50,000 and consists of a 1/1 wt/wt mixture of vinylpyrrolidone and vinylacetate (1.3/1 molar ratio of pyrrolidone/acetate). The polymer was dried in a vacuum oven at 40° C. for 16 hours.

A 2.27 g portion of the dried co-polymer and 9.0 g methanol was placed in a 20 mL vial. The vial was capped and shaken for one hour to obtain a clear solution of the co-polymer in methanol. Next, 1.0 mL aliquots of the clear solution were added to each of four 2 mL tared vials. Open vials were place on a hot plate at 40° C. for 18 hours during which the solvent methanol was allowed to evaporate slowly. A clear film was formed at the base of the vials and identified as PVP-VAc co-polymer. The vials were cooled in air for 1.5 hours, capped and re-weighed to four decimal places to obtain a net weight of each film.

### Example 2

This example measures the non-selective absorption of a toluene/isooctane mixture on the co-polymer films of polyvinylpyrrolidone and polyvinylacetate (PVP-VAc) prepared according to Example A.

A stock 1/1 v/v mixture of toluene and isooctane (both HPLC grades from Aldrich) was prepared. About 0.3 g of the liquid mixture was added to each of four vials containing the PVP-VAc films prepared in Example A. The vials were re-weighed to four decimal places, and the net weight of liquid added calculated. A measured amount of the toluene/isooctane mixture was added to each of the four vials (average g liquid/g solid was 0.357 g/g). The vials were capped tightly and then shaken vigorously for one minute. The vials stood for 48 hours at room temperature. There was no significant change in the vial weights indicating that evaporation was less than about 2 percent. The refractive index of the four supernatants were measured and found to average 1.44177 (range +/−0.0002) at 21.98° C. The refractive index of a sample of the starting mixture stored in a blank vial was measured at the same time and found to be 1.44171 at 21.56° C. The typical standard deviation of the refractive index using this instrument with the same operator on repeat measurements was 0.0005 units. Therefore, the difference in refractive index was within experimental error and not significantly different. The liquid was carefully removed from the vials and the surface of the film and interior vial walls were dabbed briefly with a small piece of absorbent paper. The vial was quickly re-weighed to give the “wet weight” of the solid. The vials were then dried in an oven for 3 hours at 50° C., cooled in air for one hour, and re-weighed to give the dry weight. The amount of solvent absorbed was determined by the difference between the wet weight and dry weights. The average amount of solvent absorbed was 0.02 g liquid/g solid.

### Example 3

This example demonstrates preparation of an ionic polymer composition from a co-polymer of polyvinylpyrrolidone and polyvinylacetate (PVP-VAc).

A 3.0 g portion of dried co-polymer and 20 mL methanol was placed in a 20 mL vial. The mixture was shaken for one hour at room temperature to obtain a clear solution of the co-polymer in methanol. Next, 0.84 mL of 70% nitric acid (13.0 mmol HNO₃) was added via pipette to the clear solution and the mixture stirred for two hours with a small magnetic stir bar. Aliquots of the solution (2.0 mL) were added to tared 10 mL glass vials and the solvent evaporated under vacuum on a hot-plate at about 70° to 80° C. for four hours to form a solid ionic polymer. The vials were cooled and 2 mL of methanol was then added to re-dissolve the solid ionic polymer. The vials were then placed on a hot-plate at about 40° to 50° C. overnight (14 hours) to obtain clear, pale-yellow films of the ionic polymer, identified as (PVP-VAc)/HNO₃, at the base of the vials. The vials containing the films were dried in a vacuum oven for 3 hours at 50° C., cooled in air for one hour, capped and re-weighed to give the weights of the dry film (close to 0.3 g measured to four decimal places).

### Example 4

This example demonstrates selective absorption of toluene over isooctane using a film of the ionic polymer composition (PVC-Va.)/HNO₃) prepared according to Example 1.

Small portions of the 1/1 v/v toluene/isooctane stock solution were added to three vials containing (PVP-VAc)/HNO₃ films described in Example 2. The average amount of liquid added was 0.89 g/g solid. The films of ionic polymer were allowed to soak in the liquid for three days at room temperature. The refractive indexes of the supernatants were measured. The average was 1.44134+/−0.0002 (at 20.96° C.). The refractive index of a portion of the starting liquid mixture stored in a blank vial was measured as 1.44257 (at 20.86° C.). The average difference in refractive index from the starting mixture of 0.00123 units was statistically significant and indicated that toluene was preferentially absorbed over isooctane by the ionic polymer of Example 1.

The average amount of liquid absorbed was 0.04 g/g solid. The selectivity ratio of absorption, α_{toluene/isooctane}, was calculated as 2.8+/−0.7 by mass balance.

These examples show that the ionic polymer formed by addition of nitric acid to the PVP-VAc co-polymer increased the selectivity for absorbing toluene over isooctane.

### Examples 5-24

Synthesis of suitable organic ionic moieties comprising at least one nitrogen atom are demonstrated in Examples 5 to 24, inclusive. These organic ionic moieties according to the invention include acetates, nitrates and/or sulfonates of 1-ethyl-2-butylpyrrolidine, triethylamine, propylamine, 1,5-dimethyl-2-pyrrolidine, 1-butylpyrrolidine, tributylamine, 1-(2-hydroxyethyl)pyrrolidine, 1-methylpiperidine, 1-pyrrolidinebutyronitrile, and 4-hydroxy-1-methylpiperidine.

### Example 5

0.2 mol of tributylamine (37.2 g) was dissolved in 100 mL H₂O and cooled to 0° C. to negative 10° C. in a NaCl ice-salt bath. 17.3 g of conc. (70 percent by volume) HNO₃ was added drop wise over 2 hr. and stirred for 2 hr. The H₂O was evaporated under vacuum at 80°C. The tributylammonium nitrate product was clear and colorless solution.

### Example 6

0.2 mol of triethylamine (20.2 g) was dissolved in 100 mL H₂O and cooled to 0° C. to negative 10° C. in NaCl ice-salt bath. 12.0 g of glacial acetic acid in 25 mL of water was added drop wise over 2 hr. and stirred for 2 hr. The H₂O was evaporated under vacuum at 80° C. The triethylammonium acetate product was clear, colorless liquid.

### Example 7

0.2 mol of 1,5-dimethyl-2-pyrrolidinone, 95%, (23.8 g) was added in 100 mL H₂O and cooled to 0° C. to negative 10° C. in a NaCl ice-salt bath. 17.3 g of conc. (70 percent by volume) HNO₃ was added drop wise over 2 hr. and stirred for 2 hr. The H₂O was evaporated under vacuum at 80° C. The 1,5-Dimethyl-2-pyrrolidinone nitrate product was a clear, colorless solution.

### Example 8

0.2 mol of 1-butylpyrrolidine (25.9 g) was dissolved in 100 mL H₂O and cooled to 0° C. to negative 10° C. in NaCl ice-salt bath. 17.3 g of conc. (70 percent by volume) HNO₃ was added drop wise over 2 hr. and stirred for 2 hr. The H₂O was evaporated under vacuum at 80° C. The 1-butylpyrrolidine nitrate product was a clear, colorless solution.

### Example 9

0.2 mol of triethylamine (20.3 g) was dissolved in 100 mL H₂O and cooled to 0° C. to negative 10° C. in a NaCl ice-salt bath. 17.3 g of conc. (70 percent by volume) HNO₃ was added drop wise over 2 hr. and stirred for 2 hr. The H₂O was evaporated under vacuum at 80° C. The triethylammonium nitrate product was a clear, colorless solution.

### Example 10

61.3 g of triethylamine was mixed with 300 g of water. 69.1 g of trifluoroacetic acid as added to 75 g of water. The two solutions were mixed and stirred for 2 hours. The water was evaporated under vacuum at 80° C., and the ionic liquid was dried under vacuum at room temperature. The weight of the triethylammonium trifluoroacetate product was about 130 g.

### Example 11

61.3 g of triethylamine was mixed with 300 g of water. 98.9 g of trichloroacetic acid was added to 75 g of water. The two solutions were mixed and stirred for 2 hours. The water was evaporated under vacuum at 80° C., and the ionic liquid was dried under vacuum at room temperature. The weight of the triethylammonium trichloroacetate product was about 41 g.

### Example 12

8.6 g of triethylamine was mixed with 40 g of water. 25.0 g of tribromoacetic acid was added to 50 g of water. The two solutions were mixed, cooled in NaCl-ice bath and stirred for 2 hours. The water was evaporated under vacuum at 80° C. and the ionic liquid was dried under vacuum at room temperature. The weight of the triethylammonium tribromoacetate product was about 12 g.

### Example 13

33.4 g of triethylamine was mixed with 150 g of water. 50.0 g of trifluoromethane salfonic acid was mixed into 40 g of water. The two solutions were mixed, cooled in NaCl-ice bath and stirred for 2 hours. The water was evaporated under vacuum at 80° C. and the ionic liquid was dried under vacuum at room temperature. The weight of the triethylammonium trifluoromethane sulfonate product was about 83 g.

### Example 14

35.4 g of 1,5-dimethyl-2pyrrolidone (95%) was dissolved in 150 g water. 29.3 g of HCl (37% in water) was added drop wise and stirred. Thereafter, 61.8 g of sodium xylene sulfulfonate (40% in water) was added, and the mixture was stirred for 2 hours. The water was removed under vacuum at 80° C. The resulting mixture had two phases, a liquid phase and a solid phase which were separated by filtration. The weight of the liquid was about 78 g, and the weight of the solid was about 8 g.

### Example 15

40 g of 1,5-dimethyl-2pyrrolidinone (95%) was dissolved in 140 g water. A trifluoromethane sulfonic acid solution (50 g in 50 g H2O) was added drop wise and stirred for 2 hours. The water was removed under vacuum at 80° C. The weight of the 1,5-dimethyl-2pyrrolidinone trifluoromethane sulfonate product as 92.5 g.

### Example 16

0.2 mol of propylamine (11.8 g) was dissolved in 100 mL H₂O and cooled to 0° C. to negative 10° C. in a NaCl ice-salt bath. 17.3 g of conc. (70 percent by volume) HNO3 was added drop wise over 2 hr. and stirred for 2 hr. The H₂O was evaporated under vacuum at 80° C. The propylammonium nitrate product was a clear, colorless solution.

### Example 17

0.2 mol of 1-ethylpyrrolidine (23.1 g) was dissolved in 100 mL H₂O and cooled to 0° C. to negative 10° C. in NaCl ice-salt bath. 17.3 g of conc. (70 percent in volume) HNO₃ was added drop wise over 2 hr. and stirred for 2 hr. The H₂O was evaporated under vacuum at 80° C. The 1-ethyl-2-pyrrolidinone nitrate product was clear and yellow in color.

### Example 18

0.2 mol of 1-(2-hydroxyethyl)pyrrolidine (23.7 g) was dissolved in 100 mL H₂O and cooled to 0° C. to negative 10° C. in NaCl ice-salt bath. 17.3 g of conc. (70 percent by volume) HNO₃ was added drop wise over 2 hr. and stirred for 2 hr. The H₂O was evaporated under vacuum at 80° C. The 1-(2-hydroxyethyl)pyrrolidine nitrate product was clear a brown solution.

### Example 19

0.2 mol of 1-methylpiperidine (20.0 g) was dissolved in 100 mL: H₂O and cooled to 0° C. to negative 10° C. in NaCl ice-salt bath. 17.3 g of conc. (70 percent by volume) HNO₃ was added drop wise over 2 hr. and stirred for 2 hr. The H₂O was evaporated under vacuum at 80° C. The 1-methylpiperidine nitrate product was a clear, yellow solution.

### Example 20

0.2 mol of 1-pyrrolidinebutyronitrile (28.5 g) was dissolved in 100 mL H₂O and cooled to 0° C. to negative 10° C. in NaCl ice-salt bath. 17.3 g of conc. (70 percent by volume) HNO₃ was added drop wise over 1 hr. and stirred for 1 hr. The H₂O was evaporated under vacuum at 80° C. The 1-pyrrolidinebutyronitrile nitrate product was a clear, brown solution.

### Example 21

0.2 mol of 4-hydroxy-1-methylpiperidine (23.0 g) was dissolved in 100 mL H₂O and cooled to 0° C. to negative 10° C. in NaCl ice-salt bath. 17.3 g of conc. (70 percent by volume) HNO₃ was added drop wise over 2 hr. and stirred for 2 hr. The H₂O was evaporated under vacuum at 80° C. The 4-hydroxy-1-methylpiperidine nitrate product was a clear, brown solution.

### Example 22

0.2 mol of propylamine (11.8 g) was dissolved in 100 mL H₂O and cooled to 0° C. to negative 10° C. in NaCl ice-salt bath. 12.0 g of glacial acetic acid in 25 mL of water was added drop wise over 2 hr. and stirred for 2 hr. The H₂O was evaporated under vacuum at 80° C.

### Example 23

0.2 mol of tributylamine (37.1 g) was dissolved in 100 mL H₂O and cooled to 0° C. to negative 10° C. in NaCl ice-salt bath. 12.0 g of glacial acetic acid in 25 mL of water was added drop wise over 2 hr. and stirred for 2 hr. The H₂O was evaporated under vacuum at 80° C.

### Example 24

0.2 mol of 1-butylpyrrolidine (25.4 g) was dissolved in 100 mL H₂O and cooled to 0° C. to negative 10° C. in NaCl ice-salt bath. 12.0 g of glacial acetic acid in 25 mL of water was added drop wise over 2 hr. and stirred for 2 hr. The H₂O was evaporated under vacuum at 80° C.

Table I shows the percentage of all dissolved hydrocarbons in product of each Example 3 to 13 for a mixture with equal weights of toluene (Tol), methylcyclohexane (mC6), and n-heptane (C7). In addition, the table gives the composition of the dissolved hydrocarbons (HC) in each product. The weight ratio of product to hydrocarbon was 1:1. These data demonstrate that the ionic moieties comprising at least one nitrogen atom in the products of Examples 5 to 24 preferentially dissolve aromatics over cycloparaffins and olefins, and olefins over paraffins.

TABLE 1
Solubility for Mixed Hydrocarbon

| Product of | % HC | wt % | wt % | wt % |
|---|---|---|---|---|
| Example 5 to 15 | Dissolved | C7 | mC6 | Tol |
| Tributylammonium | 20.0 | 14.7 | 21.3 | 64.0 |
| Nitrate | | | | |
| Triethylammonium | 3.0 | 9.7 | 13.4 | 76.9 |
| Acetate | | | | |
| 1,5-Dimethy- | 12.0 | 7.6 | 12.6 | 79.9 |
| 2pyrrolidinone | | | | |
| Nitrate | | | | |
| 1-Butylpyrrolidine | 7.6 | 12.4 | 14.3 | 73.3 |
| Nitrate | | | | |
| Triethylammonium | 4.7 | 16.8 | 18.0 | 65.1 |
| Nitrate | | | | |
| Triethylammonium | 9.0 | 8.9 | 12.1 | 79.0 |
| Trifluoroacetate | | | | |
| Triethylammonium | −5.4 | 28.2 | 58.9 | 12.8 |
| Trichloroacetate | | | | |
| Triethylammonium | 5.4 | 31.8 | 31.7 | 36.6 |
| Tribromoacetate | | | | |
| Triethylammonium | 5.1 | 6.9 | 9.1 | 84.1 |
| Trifluoromethane | | | | |
| Sulfonate | | | | |
| 1,5-Dimethyl- | 4.2 | 23.7 | 25.2 | 51.1 |
| 2pyrrolidinone | | | | |
| Xylene Sulfonate | | | | |
| 1,5-Dimethyl- | 5.4 | 11.3 | 14.5 | 74.2 |
| 2pyrrolidinone | | | | |
| Trifluoromethane | | | | |
| Sulfonate | | | | |

HC mixture: n-Heptane, methylcyclohexane and toluene at weight ratio of 1:1:1

TABLE II
Solubility for Mixed Hydrocarbon

| | | IM/HC = | IM/HC = | IM/HC = |
|---|---|---|---|---|
| Ionic moiety name | | 1/5 | 2.5/1 | 5/1 |
| 1-(2-Hydroxyethyl)- | % HC | 3.1 | 8.6 | 12.5 |
| pyrrolidine Nitrate | Dissolved | | | |
| | wt % C7 | 16.7 | 18.5 | 14.7 |
| | wt % C7⁼ | 20.8 | 19.9 | 16.2 |
| | wt % mC6 | 18.0 | 19.7 | 17.4 |
| | wt % tol | 44.5 | 41.9 | 51.7 |
| 1-Methylpiperidine | % HC | 4.5 | 9.5 | 12.7 |
| Nitrate | Dissolved | | | |
| | wt % C7 | 17.1 | 16.4 | 13.6 |
| | wt % C7⁼ | 19.8 | 17.8 | 15.0 |
| | wt % mC6 | 17.9 | 17.9 | 16.2 |
| | wt % tol | 45.3 | 47.9 | 55.2 |
| 1-Pyrrolidinebutyronitrile | % HC | 2.6 | 5.8 | 9.0 |
| Nitrate | Dissolved | | | |
| | wt % C7 | 9.6 | 8.8 | 5.2 |
| | wt % C7⁼ | 14.3 | 11.6 | 8.0 |
| | wt % mC6 | 11.6 | 11.3 | 9.5 |
| | wt % tol | 64.5 | 68.3 | 77.3 |
| 4-Hydroxy-1- | % HC | 4.5 | 6.4 | 6.5 |
| methylpiperidine | Dissolved | | | |
| Nitrate | wt % C7 | 21.6 | 20.0 | 24.6 |
| | wt % C7⁼ | 24.1 | 21.7 | 24.6 |
| | wt % mC6 | 22.4 | 21.7 | 24.6 |
| | wt % tol | 31.9 | 36.5 | 26.0 |

HC mixture: n-Heptane, 1-Heptene, methylcyclohexane and toluene at weight ratio of 1:1:1:1

Table II shows the percentage of all dissolved hydrocarbons in each model ionic moiety for a mixture with equal weights of toluene, methylcyclohexane, 1-heptene and n-heptane. In addition, the table gives the composition of the dissolved hydrocarbons in the IL. The weight ratio of a model ionic moiety to hydrocarbon was 5:1, 2.5:1 and 1:1. The table demonstrates that these model organic ionic moieties preferentially dissolve olefins over cycloparaffins and paraffins.

For the purposes of the present invention, “predominantly” is defined as more than about fifty percent. “Substantially” is defined as occurring with sufficient frequency or being present in such proportions as to measurably affect macroscopic properties of an associated compound or system. Where the frequency or proportion for such impact is not clear, substantially is to be regarded as about twenty percent or more. The term “a feedstock consisting essentially of” is defined as at least 95 percent of the feedstock by volume. The term “essentially free of” is defined as absolutely except that small variations which have no more than a negligible effect on macroscopic qualities and final outcome are permitted, typically up to about one percent.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. A process which comprises: contacting a fluid mixture of two or more volatile hydrocarbon compounds of different classification types with a first side of a membrane that contains an ionic polymer having organic ionic moieties consisting of nitrogen containing organic cations; maintaining a suitable differential of a driving force across the membrane from the first side to a permeate side opposite thereto, under which differential of a driving force the membrane exhibits a selective permeability for one class of the compounds of the fluid mixture, and recovering a permeate enriched in one or more compounds of the select class from the permeate side of the membrane.

20. The process according to claim 19 wherein the membrane exhibits a permeability of at least 0.1 Barrer for one of the compounds of the fluid mixture.

21. (canceled)

22. The process according to claim 19 wherein at least a plurality of the repeating structural units comprise organic ionic moieties consisting of anions and nitrogen containing cations having a ring structure of 5 to 6 members comprising 1 to 3 nitrogen atoms, and 2 to 5 carbon atoms.

23. The process according to claim 19 wherein at least a plurality of the repeating structural units are represented by 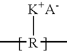
where, K⁺ A⁻ is an organic ionic moiety consisting of a nitrogen containing cation K³⁰ and an anion A⁻, and R is a organic group comprising 2 or more carbon atoms, wherein the nitrogen containing cations comprise a ring structure of 5 members comprising a single nitrogen atom, and carbon atoms.

24. The process according to claim 19 wherein at least a plurality of the nitrogen containing cations comprise a ring structure of 5 members comprising a nitrogen atom, 3 carbon atoms, and an atom selected from the group consisting of oxygen and sulfur atoms.

25. (canceled)

26. (canceled)

27. (canceled)

28. A process which comprises: contacting a fluid mixture of two or more related volatile organic compounds with a first side of a membrane that contains an ionic polymer of repeating structural units having organic ionic moieties at least a plurality of the repeating structure units are represented by 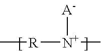
where R is a organic unit comprising 2 or more carbon atoms, and A⁻ is an anion.

29. The process according to claim 28 wherein the membrane exhibits a permeability of at least 0.1 Barrer for one of the organic compounds of the fluid mixture.

30. The process according to claim 23 wherein the organic unit R comprises 2 carbon atoms.

31. An ionic polymer composition comprising repeating structural units of which at least a plurality are represented by 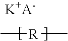
where K⁺ A⁻ is an organic ionic moiety consisting of a nitrogen containing cation K⁺ and an anion A⁻, and R is a organic group comprising 2 carbon atoms.

32. The ionic polymer composition according to claim 31 wherein the nitrogen containing cations comprise a ring structure of 5 members each ring comprising one nitrogen atom.

33. The ionic polymer composition according to claim 32 wherein the nitrogen containing cations comprise a ring structure having one substitiuent oxygen atom.
